(19) United States
(12) Patent Application Publication
(10) Pub. No.: US 2025/0087022 A1
(43) Pub. Date: Mar. 13, 2025

(54) Authentication by Habitual Eye Tracking Data

(71) Applicant: Hewlett-Packard Development Company, L.P., Spring, TX (US)

(72) Inventor: Kasim Chang Chien, Taipei City (TW)

(73) Assignee: Hewlett-Packard Development Company, L.P., Spring, TX (US)

(21) Appl. No.: 18/294,787

(22) PCT Filed: Aug. 23, 2021
(86) PCT No.: PCT/US2021/047103

§ 371 Date: Feb. 2, 2024

(51) Int. Cl. G06V 40/18; G06F 21/36; G06V 40/20

(52) U.S. Cl. CPC G06V 40/18; G06F 21/36; G06V 40/20

(57) ABSTRACT

In an example implementation according to aspects of the present disclosure, a system comprises a display device, a gaze tracking device, and processor operatively coupled with a computer readable storage medium and instructions stored on the computer readable storage medium that, when executed by the processor, direct the processor to display, by the display device, a pattern of images to a user; capture, by the gaze tracking device, involuntary eye movements of the user viewing the pattern of images on the display device; and authenticate the user based on the involuntary eye movements of the user matching a stored user preference information.

### BACKGROUND

Head mounted devices may be used to provide an altered reality to a user. An extended reality (XR) device may include a virtual reality (VR) device, an augmented reality (AR) device, and/or a mixed reality (MR) device. XR devices may include displays to provide a VR, AR, or MR experience to the user by providing video, images, and/or other visual stimuli to the user via the displays. XR devices may be worn by a user. Some XR devices include an eye tracking element to detect user eye movements.

### BRIEF DESCRIPTION OF THE DRAWINGS

Many aspects of the disclosure can be better understood with reference to the following drawings. While several examples are described in connection with these drawings, the disclosure is not limited to the examples disclosed herein.

FIG. 1 illustrates a block diagram of a computing system for authenticating a user of a head mountable display (HMD) by habitual eye tracking, according to an example;

FIG. 2 illustrates a diagram of a user wearing an HMD which authenticates the user by habitual eye tracking, according to an example;

FIG. 3 illustrates a screenshot of displayed images used to authenticate a user by habitual eye tracking, according to an example;

FIG. 4 illustrates a flow diagram of a process to authenticate a user of an HMD by habitual eye tracking, according to an example;

FIG. 5 illustrates a block diagram of a non-transitory storage medium storing machine-readable instructions to authenticate a user of an HMD by involuntary eye tracking, according to an example;

FIG. 6 illustrates an operational architecture of a system for authenticating a user of an HMD by habitual eye tracking, according to another example;

FIG. 7 illustrates a sequence diagram for a process to authenticate a user of an HMD by habitual eye tracking, according to another example; and

FIG. 8 illustrates a block diagram of a computing system, which is representative of any system or visual representation of systems in which the various applications, services, scenarios, and processes disclosed herein may be implemented.

### DETAILED DESCRIPTION

Extended reality (XR) devices may provide an altered reality to a user by providing video, audio, images, and/or other stimuli to a user via a display. As used herein, the term “XR device” refers to a device that provides a virtual reality (VR), augmented reality (AR), and/or mixed reality (MR) experience for a user.

The XR device may be experienced by a user through the use of a head mount device (e.g., a headset). For example, a user may wear the headset in order to view the display of the XR device and/or experience audio stimuli of the XR device. As used herein, the term “extended reality” refers to a computing device generated scenario that simulates experience through senses and perception. In some examples, an XR device may cover a user's eyes and provide visual stimuli to the user via a display, thereby substituting an “extended” reality (e.g., a “virtual reality”, “augmented reality” and/or “mixed reality”) for actual reality. In some examples, an XR device may include an eye tracking element. The eye tracking element may track a user's eye movements.

Computing devices provide access to data and applications to users. Such informational exchange is independent of geographic boundaries and may be portable. For example, a user may access certain information stored on their home computing device even when they are not at home, for example through an XR device. The global nature of information exchange provides countless benefits to users of those computing devices as information has become more widespread and portable. However, the user must be authenticated prior to accessing the private information or personal applications.

While a user may be prompted to enter passwords, credentials, etc. on the XR device prior to accessing the information or applications, this generally requires the user to take off the HMD and interact with the system. Furthermore, many users have multiple passwords and credentials for various applications. It can become cumbersome not only enter all of this data, but to remember and keep track of this data.

The present disclosure provides an HMD system which may authenticate the user based on habitual eye tracking. This allows the user to be authenticated on the XR device without the user needing to enter or remember credentials.

In an example implementation according to aspects of the present disclosure, a system comprises a display device, a gaze tracking device, and processor operatively coupled with a computer readable storage medium and instructions stored on the computer readable storage medium that, when executed by the processor, direct the processor to display, by the display device, a pattern of images to a user; capture, by the gaze tracking device, involuntary eye movements of the user viewing the pattern of images on the display device; and authenticate the user based on the involuntary eye movements of the user matching a stored user preference information.

In another example implementation, a method of authorizing a user of an HMD comprises maintaining a database indicating habitual eye tracking data for a user. The method includes displaying a plurality of images in different areas on a display device of the HMD and sensing habitual eye tracking data for a user while the viewer sequentially views a set of images of the plurality of images. The method also includes authenticating the viewer by comparing the received habitual eye tracking data with the stored habitual eye tracking data for the user.

In yet another example, a non-transitory computer readable medium comprises instructions executable by a processor to maintain user preference data in a cloud-based data repository to be ingested by a machine learning computing system. The instructions executable by the processor further receive eye tracking data in response to displaying a sequence of images to a user of an HMD. The instructions executable by the processor further query the machine learning computing system to authorize the user of the HMD based on the received eye tracking data and the user preference data maintained in the cloud-based data repository.

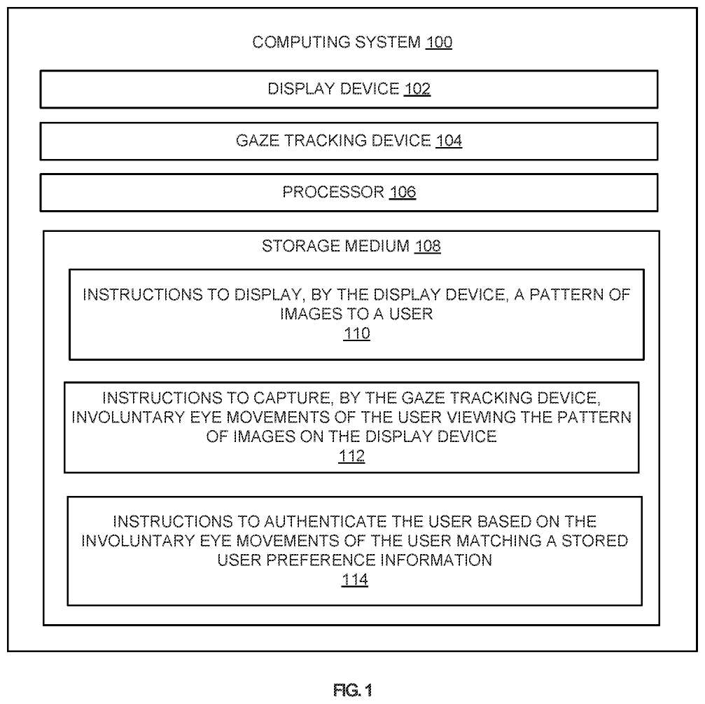

FIG. 1 illustrates a block diagram of computing system 100 for authenticating a user of an HMD by habitual eye tracking, according to an example. Computing system 100 depicts display device 102, gaze tracking device 104, processor 106, and storage medium 108. As an example of computing system 100 performing its operations, storage medium 108 may include instructions 110-114 that are executable by processor 106. Thus, storage medium 108 can be said to store program instructions that, when executed by processor 106, implement the components of computing system 100.

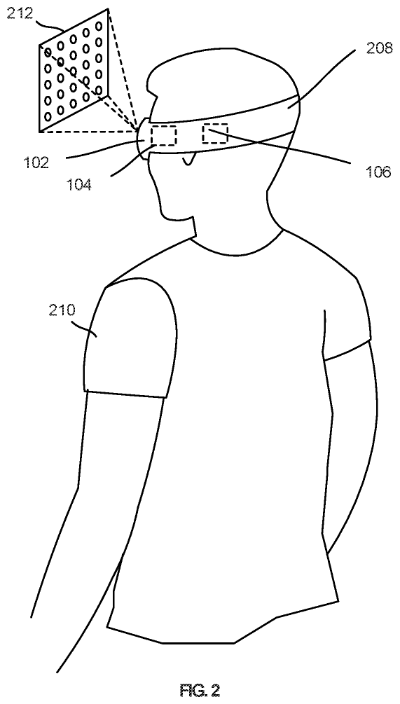

Computing system 100 may include display device 102. Display device 102 refers to any device that presents visual information to a user. Examples of display devices include computer screens, smart device screens, tablet screens, and mobile device screens. In one particular example, display device 102 is formed in a headset that is worn by a user when using an enhanced reality system. An example of such a headset is depicted in FIG. 2 below.

Computing system 100 includes gaze tracking device 104 to capture eye movements of a user looking at display device 102. In general, gaze tracking device 104 is an electronic system that detects and reports at least one user's gaze direction in one or both eyes. The user's gaze direction may refer to the direction of a gaze ray in three-dimensional (3D) space that originates from near or inside the user's eye and indicates the path along which their foveal retina region is pointed. That is, gaze tracking device 104 determines where a user is looking. In some examples, gaze tracking device 104 reports the gaze direction relative to the object on which the gaze terminates. For example, gaze tracking device 104 may determine what part of display device 102 the user is looking at. In enhanced reality head mounted displays or other virtual display systems, the gaze ray may be projected into a virtual space that is displayed in front of the user's eye, such that the gaze ray terminates at some virtual point behind display device 102. In some examples, gaze tracking device 104 tracks the gaze of more than one user at a time.

Gaze tracking device 104 may detect the eye's orientation and position in a variety of ways. In one example, gaze tracking device 104 observes the eye using an infrared or visible light camera. The position of the eye anatomy within the camera's image frame can be used to determine where the eye is looking. In some examples, illuminators are used to create reflective glints on the eye's anatomy, and the position of the glints is used to track the eye. In these examples, entire patterns of light can be projected onto the eye, both through diffuse or point illuminators like standard LEDs, collimated LEDs, or low powered lasers.

In some examples, gaze tracking device 104 is integrated onto display device 102. For example, on a desktop computer or mobile phone, a camera could be directed towards the user to track their eye movement and position. In another example, in an enhanced reality headset, gaze tracking device 104 may be formed on a same surface of an internal part of the housing that display device 102 is formed and may point towards the user's face.

Processor 106 includes the hardware architecture to retrieve executable code from the memory and execute the executable code. As specific examples, Processor 106 as described herein may include a controller, an application-specific integrated circuit (ASIC), a semiconductor-based microprocessor, a central processing unit (CPU), and a field-programmable gate array (FPGA), and/or other hardware device.

Storage medium 108 represents any number of memory components capable of storing instructions that can be executed by processor 106. As a result, storage medium 108 may be implemented in a single device or distributed across devices. Likewise, processor 106 represents any number of processors capable of executing instructions stored by storage medium 108.

In particular, the executable instructions stored in storage medium 108 include, as an example, instructions 110 represent program instructions that when executed by processor 106 cause computing system 100 to display, by display device 102, a pattern of images to a user. In some examples, the pattern of images includes images relating to different sceneries, colors, topics, or sizes that are of interest to the user. The pattern of images may be different each time the user is authenticated, and the user may not be familiar with the pattern of images or any of the images within it.

It should be noted that the user is not authenticated based on the user intentionally recognizing images on display device 102. Although the user may be away of their interests, colors they are drawn to, sceneries/landmarks they identify with, etc., the user is not expected to intentionally remember and gaze at these objects when being authenticated. In this manner, the user does not need to remember their password or credentials.

Instructions 112 represent program instructions that when executed by processor 106 cause computing system 100 to capture, by the gaze tracking device, involuntary eye movements of the user viewing the pattern of images on the display device. In some examples, the involuntary eye movements include a duration of a pause of the user, a blink count of the user, or a pupillary variation of the user in response to the display of the pattern of images displayed on display device 102. As stated above, the user's eye movements may not be intentionally directed to different areas of the pattern of images.

Instructions 114 represent program instructions that when executed by processor 106 cause computing system 100 to authenticate the user based on the involuntary eye movements of the user matching a stored user preference information. The stored user preference information may be information previously captured and logged by computing system 100. For example, the user may be presented with a variety of images when the user sets up their authentication method. In this manner, computing system 100 may receive a variety of information about what the user is drawn to in images, such as colors, designs, sceneries, faces, topics of interest, etc. In some examples, the user is authenticated by querying a machine learning computing system to authorize the user of the computing system based on the received involuntary eye tracking data and user preference data stored in the cloud-based data repository.

FIG. 2 illustrates a diagram of a user wearing an HMD which authenticates the user by habitual eye tracking, according to an example. As described above, computing system 100 may be formed in an enhanced reality system. Accordingly, display device 102 may be an HMD device that is worn by user 210 to generate visual, auditory, and other sensory environments, to detect user input, and to manipulate the environments based on the user input. While FIG. 2 depicts a particular configuration of XR HMD 208, any type of enhanced reality headset may be used in accordance with the principles described herein.

FIG. 2 also depicts dashed boxes representing processor 106 and gaze tracking device 104. While FIG. 2 depicts these components disposed on XR HMD 208, either of these components may be placed on another device. For example, processor 106 may be found on a different computing device. That is, XR HMD 208 is communicatively coupled to a host computing device such that execution of computer readable program code by a processor associated with the host computing device causes a view of an enhanced reality environment to be displayed in XR HMD 208. In some examples, processor 106 of computing system 100 may be disposed on this host computing device.

In some examples, XR HMD 208 implements a stereoscopic head-mounted display that provides separate images for each eye of the user. In some examples, XR HMD 208 may provide stereo sound to the user. In an example, XR HMD 208 may include a head motion tracking sensor that includes a gyroscope and/or an accelerometer.

As described above, via display device 102 and gaze tracking device 104, user 210 may be authenticated via habitual movements of the eye during login/authentication and comparing those movements to an eye movement authentication pattern for the user. In some examples, display device 102 displays a visual sequence of images 212. Such visual sequence of images 212 provides images in various locations, colors, sizes, interests, etc. to the identity of user 210. In the example depicted in FIG. 2, visual sequence of images 212 is a grid, however visual sequence of images 212 may take other forms. For example, visual sequence of images 212 may be a scenic image where user 210 looks at different parts of an image.

In some examples, XR HMD 208 may detect when a user takes on/off XR HMD 208 and computing system 100 may take appropriate action. For example, when taken off, computing system 100 may re-trigger the authentication process and end a current session. In this example, computing system 100 may include an inertial measurement unit or other motion sensing unit to detect when XR HMD 208 is taken off completely (not just resting on the head). The same sensing unit may be used to determine when XR HMD 208 is put back on a user head. Computing system 100 may first identify the user of XR HMD 208 before authenticating the user using habitual eye tracking. User 210 may first be identified by identifying an iris of a user or entering another form of authentication credentials such as a voice ID or touch ID to indicate who they are.

As described above, the habitual eye movement authentication pattern to authenticate the user is user-specific and so may be transferable to other devices. In this example, the habitual eye movement authentication pattern is associated with supporting authentication credentials (such as voice ID, touch ID, or password) such that the habitual eye movement authentication pattern is retrieved on any device where supporting authentication credentials are input. For example, if user 210 switches to a different enhanced reality headset, user 210 may input their voice ID or touch ID.

Computing system 100 may uniquely identify them from a database of users. After this, computing system 100 logs the device name in the user's account and creates encrypted information that includes their unique eye movement authentication pattern which allows them to login. In some examples, computing system 100 associates the eye movement a pattern with the new device ID so the next time they use the device, they can provide username via username voice ID or touch ID.

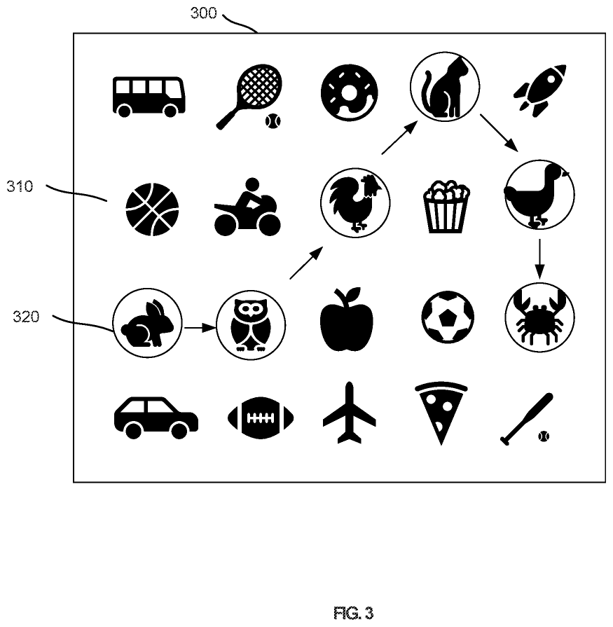

FIG. 3 illustrates a screenshot of displayed images used to authenticate a user by habitual eye tracking, according to an example. That is, FIG. 3 depicts operation of computing system 100 in an authentication mode. As seen in screenshot 300, a user is prompted to view a sequence of images 310. Sequence of images 310 includes a variety of image types which may be associated with an interest. For example, sequence of images 310 includes food, vehicles, sports, and animals.

In response to being shown, the user habitually is drawn to their interest. In this example scenario, the user is drawn to animals over the other image types. Therefore, the user moves their eyes in a habitual eye movement authentication pattern 320 which is unique to them. Habitual eye movement authentication pattern 320 is recorded as being the focus of a user's eyes. Note that while FIG. 3 depicts a particular order of images, any order may be implemented.

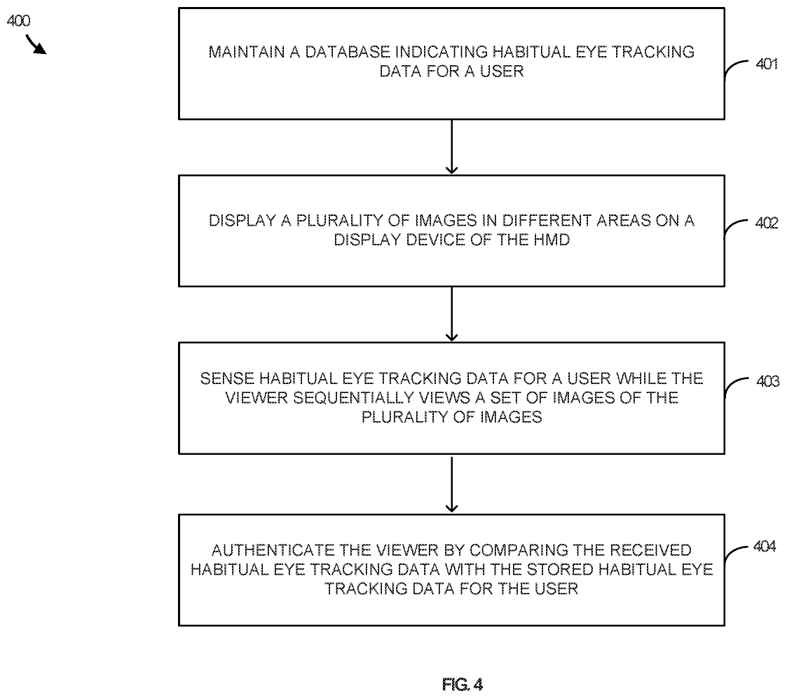

FIG. 4 illustrates a flow diagram of method 400 to, according to an example. Some or all of the steps of method 400 may be implemented in program instructions in the context of a component or components of an application used to carry out the user authentication. Although the flow diagram of FIG. 4 shows a specific order of execution, the order of execution may differ from that which is depicted. For example, the order of execution of two of more blocks shown in succession by be executed concurrently or with partial concurrence. All such variations are within the scope of the present disclosure.

Referring parenthetically to the steps in FIG. 4, method 400 maintains a database indicating habitual eye tracking data for a user, at 401. For example, an eye tracking device may display a variety of images/image types to a user. In response to the images being displayed, the user may instinctually move toward images or in a sequence over the image in a unique manner from other users. For example, multiple versions of a company logo may be displayed to a user, such as logos associated with interest (e.g., gaming products, music, fashion, books), from a different time periods, having different color scenes, having different sizes, etc. The user may be drawn to a version of the logo that most speaks to them. For example, the user may be drawn to an image of a gaming logo from ten years ago when the user was highly interested in gaming. The user may be provided with a variety of different image sequences and a user database is created and maintained for future use. In some examples, the database indicating the habitual eye tracking data for the user is stored in a cloud-based data repository to be ingested by a machine learning computing system.

Method 400 displays a plurality of images in different areas on a display device of the HMD, at 602. This may be a different sequence of images each time the user is authenticated. From the example from 401, the user may be shown a sequence of twenty versions of a company's logo. The user may have been shown some of the versions of the company's logo in different sequences in previous authentications. Although the user may be familiar with various versions of the logo, the user may be unaware that one or more of the logo versions is associated with them. Even if the user knows that they are interested in different versions, the user does not need to remember or intentionally draw their eyes to any version of the logo to get authenticated and gain access to information or an application.

Method 400 senses habitual eye tracking data for a user while the viewer sequentially views a set of images of the plurality of images, at 403. The habitual eye tracking data includes eye movements by the user toward or away from different images or areas of the display where the sequence of images is displayed.

The habitual eye tracking data may be sensed by detecting a pattern scanning sequence of the user in response to the display of the plurality of images in the different areas on the display device of the HMD. For example, the user may perform an involuntary scan of the sequence of images before focusing on any specific image or area on the display. The user may not even be aware of their habit to scan the sequence in a different pattern when shown a sequence of images.

In other examples, the habitual eye tracking data may be sensed by detecting a direction, speed, velocity, acceleration, momentum, etc. of sight movement of the user in response to the display of the plurality of images in the different areas on the display device of the HMD. For example, the user may habitually scan a sequence of images by starting in the top-left corner of the display and then scan to the right-bottom. The user may start scanning the sequence of images slowly, and then accelerate quickly as they continue their scan.

In other examples, the habitual eye tracking data may be sensed by detecting a duration of a pause of the user in response to the display of the plurality of images in the different areas on the display device of the HMD. For example, the user may habitually pause for an average fraction of a second in response to being shown a sequence of images. Furthermore, the user's pause may differ based on the various characteristics of the sequence of images. For example, the user may pause longer when the user is shown more images in the sequence of images.

In yet another example, the habitual eye tracking data may be sensed by detecting a blink count on each image of the user in response to the display of the plurality of images in the different areas on the display device of the HMD. For example, the user may blink more when the user is shown a sequence of images with brighter colors than when the user is shown a sequence of images with darker colors.

In some examples, the habitual eye tracking data may be sensed by detecting a pupillary variation of the user in response to the display of the plurality of images in the different areas on the display device of the HMD. For example, the user's pupils may become wider or vary faster when displayed a sequence of images that the user is more interested in.

Method 400 authenticates the viewer by comparing the received habitual eye tracking data with the stored habitual eye tracking data for the user, at 404. For example, the stored habitual eye tracking data may be retrieved from the cloud-based data repository. The stored habitual eye tracking data and the received habitual eye tracking data for the current authentication session may be ingested by a machine learning computing system to determine that the user is authenticated.

In some examples, habitual eye tracking data for a plurality of users may also be collected. In this example, a habitual profile is determined for each subset of the plurality of users. A habitual profile may then be identified for the user based on the maintained habitual eye tracking data for the user. The user would then be authorized based the sensed eye tracking data and the identified habitual profile for the user.

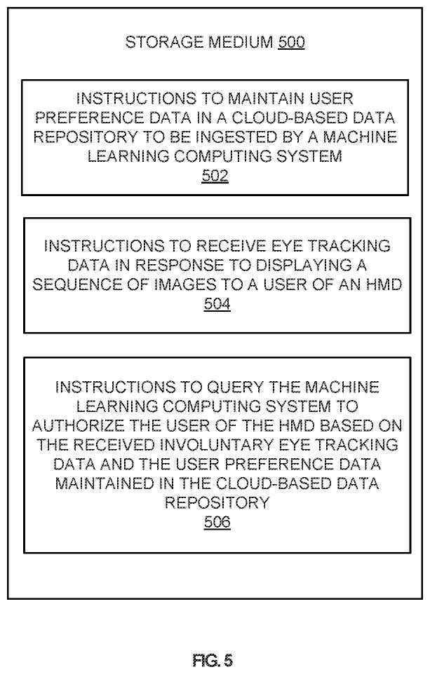

FIG. 5 illustrates a block diagram of non-transitory storage medium 500 storing machine-readable instructions that upon execution cause a system to authenticate a user of an HMD by involuntary eye tracking, according to an example. Storage medium is non-transitory in the sense that is does not encompass a transitory signal but instead is made up of a memory component configured to store the relevant instructions.

The machine-readable instructions include instructions 502 to maintain user preference data in a cloud-based data repository to be ingested by a machine learning computing system. The machine-readable instructions also include instructions 504 to receive eye tracking data in response to displaying a sequence of images to a user of an HMD. The machine-readable instructions also include instructions 506 to query the machine learning computing system to authorize the user of the HMD based on the received eye tracking data and the user preference data maintained in the cloud-based data repository.

In one example, program instructions 502-506 can be part of an installation package that when installed can be executed by a processor to implement the components of a computing device. In this case, non-transitory storage medium 500 may be a portable medium such as a CD, DVD, or a flash drive. Non-transitory storage medium 500 may also be maintained by a server from which the installation package can be downloaded and installed. In another example, the program instructions may be part of an application or applications already installed. Here, non-transitory storage medium 500 can include integrated memory, such as a hard drive, solid state drive, and the like.

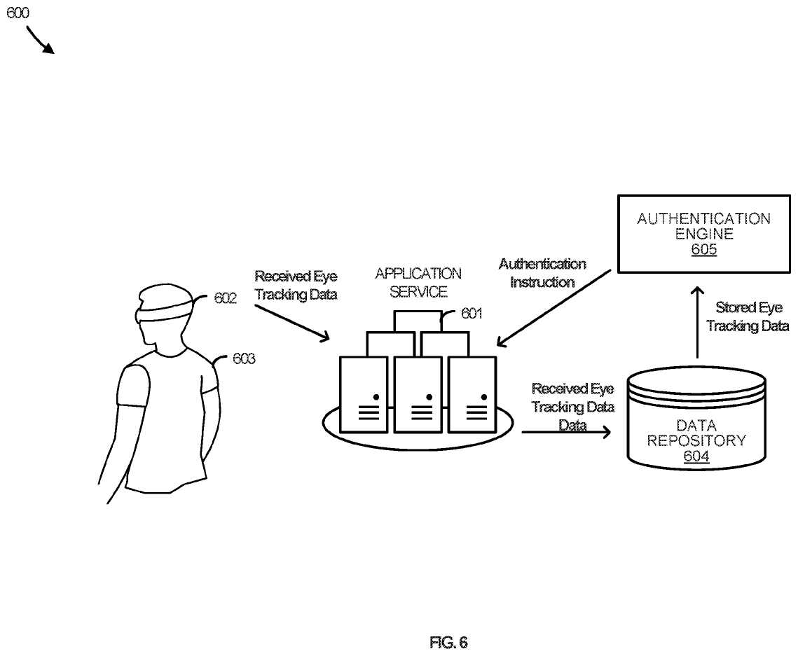

FIG. 6 illustrates an operational architecture of a system for authenticating a user by habitual gaze tracking, according to another example. FIG. 6 illustrates operational scenario 600 that relates to what occurs when a user is displayed with various sceneries with a variety of landmarks that may interest a user. Furthermore, FIG. 6 illustrates what occurs when habitual eye tracking data is stored in a data repository and the user is authenticated using machine learning algorithms or techniques in an authentication engine. Operational scenario 600 includes application service 601, computing device 602, user 603, data repository 604, and authentication engine 605.

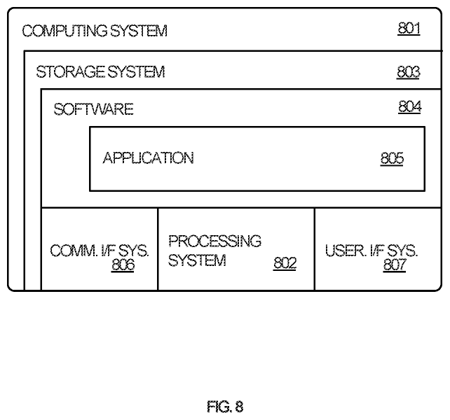

Application service 601 is representative of any device capable of running an application natively or in the context of a web browser, streaming an application, or executing an application in any other manner. Examples of application service 601 include, but are not limited to, personal computers, mobile phones, tablet computers, desktop computers, laptop computers, wearable computing devices, or any other form factor, including any combination of computers or variations thereof. Application service 601 may include various hardware and software elements in a supporting architecture suitable for performing process 700. One such representative architecture is illustrated in FIG. 8 with respect to computing system 801.

Application service 601 also includes a software application or application component capable of authenticating a user by habitual eye tracking data in accordance with the processes described herein. The software application may be implemented as a natively installed and executed application, a web application hosted in the context of a browser, a streamed or streaming application, a mobile application, or any variation or combination thereof.

Display device 602 is capable of displaying an image or sequence of images to the user. Display device 602 is also capable of tracking a user's eye movements in response to displaying the image. Examples of display device 602 include any or some combination of the following: an XR device, an All-In-One (AIO) HMD, an HMD executing an application in combination with another computing device, such as a desktop computer, a notebook computer, a tablet computer, a smartphone, a game appliance, a wearable device (e.g., a smart watch, a head-mount device, etc.), or any other type of electronic device.

As shown in FIG. 6, display device 602 may collect user eye tracking data in response to displaying a variety of sceneries having a variety of landmarks to the user. Display device 602 transfers the collected user eye tracking data to application service 601. Application service 601 may transfer the collected user eye tracking data to data repository 604 to update the user profile and to authentication engine 605 to authenticate the user.

Data repository 604 may be any data structure (e.g., a database, such as a relational database, non-relational database, graph database, etc.), a file, a table, or any other structure which may store a collection of data. Authentication engine 605 may be a rule-based engine which may process a user's habitual eye tracking movements in response to viewing an image (e.g., scenery) and/or combinations of images (e.g., combinations of landmarks in a scenery) to determine whether the user is authenticated to user display device 602 under a certain user profile. Authentication engine 605 may further include a data filtration system which filters the eye tracking data to determine data which will be used in generating the authentication instruction. In some examples, authentication engine 605 may use a statistical supervised model to filter the data and generate the authentication instruction. Based on the data stored in data repository 604 and the collected eye tracking data, authentication engine 605 is able to authenticate the user based on habitual eye tracking data and create an authentication instruction. The authentication instruction is then communicated to display device 602 via application service 601.

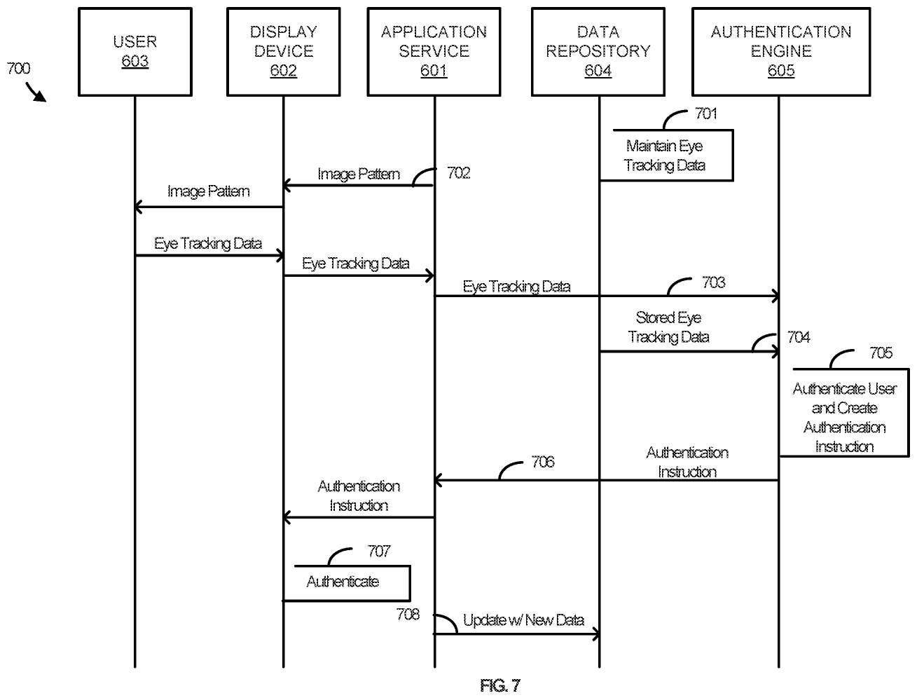

FIG. 7 illustrates a sequence diagram for process 700 to authenticate a user based on a user's habitual eye tracking data, according to another example. Specifically, the sequence diagram illustrates an operation of system 600 to generate an authentication instruction using habitual eye tracking data stored in a data repository and processed using machine learning techniques in an authentication engine.

In a first step, data repository 604 collects and maintains stored eye tracking data, at 701. Display device 602 receives an image pattern (e.g., scenery) to display to user 603, at 702. Display device 602 then receives habitual eye tracking data from user 603 in response to displaying the image pattern and transfers the habitual eye tracking data to authentication engine 605 over application service 601, at 703.

In a next step, the stored eye tracking data is retrieved from data repository 604 and transferred to authentication engine 605 to be processed with the recently received habitual eye tracking data using machine learning techniques, 704. Authentication engine 605 then processes the recently received habitual eye tracking data and the stored eye tracking data authenticate user 603 and create an authentication instruction, at 705. Once the authentication instruction has been created, the authentication instruction is transferred to application service 601, and application service 601 in turn transfers the authentication instruction to display device 602, at 706. In response to receiving the authentication instruction, display device 602 authenticates the user to allow the user to access the user profile (at 607). In a final operation, data repository 604 is updated with the recently received habitual eye tracking data, at 608.

FIG. 8 illustrates a block diagram of computing system 801, which is representative of any system or visual representation of systems in which the various applications, services, scenarios, and processes disclosed herein may be implemented. Examples of computing system 801 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 804, communication interface system 806, and user interface system 807. Processing system 802 is operatively coupled with storage system 803, communication interface system 806, and user interface system 807.

Processing system 802 loads and executes software 804 from storage system 803. Software 804 includes application 805, which is representative of the processes discussed with respect to the preceding FIGS. 1-5, including method 200. When executed by processing system 802 to enhance an application, software 804 directs processing system 802 to operate as described herein for at least the various processes, operational scenarios, and sequences discussed in the foregoing examples. Computing system 801 may optionally include additional devices, features, or functionality not discussed for purposes of brevity.

Referring still to FIG. 8, processing system 802 may comprise a micro-processor and other circuitry that retrieves and executes software 804 from storage system 803. Processing system 802 may be implemented within a single processing device but may also be distributed across multiple processing devices or sub-systems that cooperate in executing program instructions. Examples of processing system 802 include general purpose central processing units, graphical processing unites, application specific processors, and logic devices, as well as any other type of processing device, combination, or variation.

Storage system 803 may comprise any computer readable storage media readable by processing system 802 and capable of storing software 804. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 804 may be implemented in program instructions and among other functions may, when executed by processing system 802, direct processing system 802 to operate as described with respect to the various operational scenarios, sequences, and processes illustrated herein. Software 804 may include program instructions for implementing method 200.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 804 may include additional processes, programs, or components, such as operating system software, virtual machine software, or other application software, in addition to or that include application 805. Software 804 may also comprise firmware or some other form of machine-readable processing instructions executable by processing system 802.

In general, software 804 may, when loaded into processing system 802 and executed, transform a suitable apparatus, system, or device (of which computing system 801 is representative) overall from a general-purpose computing system into a special-purpose computing system. Indeed, encoding software 804 on storage system 803 may transform the physical structure of storage system 803. The specific transformation of the physical structure may depend on various factors in different examples of this description. Such factors may include, but are not limited to, the technology used to implement the storage media of storage system 803 and whether the computer-storage media are characterized as primary or secondary storage, as well as other factors.

If the computer readable storage media are implemented as semiconductor-based memory, software 804 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 806 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 807 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 807. In some cases, the input and output devices may be combined in a single device, such as a display capable of displaying images and receiving touch gestures. The aforementioned user input and output devices are well known in the art and need not be discussed at length here. User interface system 807 may also include associated user interface software executable by processing system 802 in support of the various user input and output devices discussed above.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. Certain inventive aspects may be appreciated from the foregoing disclosure, of which the following are various examples.

The functional block diagrams, operational scenarios and sequences, and flow diagrams provided in the FIG.s are representative of example systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. It should be noted that a method could alternatively be represented as a series of interrelated states or events, such as in a state diagram. Moreover, not all acts illustrated in a methodology may be required for a novel example.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

1. A method of authorizing a user of a head mountable device (HMD), comprising:
maintaining a database indicating habitual eye tracking data for a user;
displaying a plurality of images in different areas on a display device of the HMD;
sensing habitual eye tracking data for a user while the viewer sequentially views a set of images of the plurality of images; and
authenticating the viewer by comparing the received habitual eye tracking data with the stored habitual eye tracking data for the user.

2. The method of claim 1, wherein sensing the habitual eye tracking data comprises detecting a pattern scanning sequence of the user in response to the display of the plurality of images in the different areas on the display device of the HMD.

3. The method of claim 1, wherein sensing the habitual eye tracking data comprises detecting at least one of a speed, velocity, acceleration, and momentum of sight movement of the user in response to the display of the plurality of images in the different areas on the display device of the HMD.

4. The method of claim 1, wherein sensing the habitual eye tracking data comprises detecting a duration of a pause of the user in response to the display of the plurality of images in the different areas on the display device of the HMD.

5. The method of claim 1, wherein sensing the habitual eye tracking data comprises detecting a blink count on each image of the user in response to the display of the plurality of images in the different areas on the display device of the HMD.

6. The method of claim 1, wherein sensing the habitual eye tracking data comprises detecting a pupillary variation of the user in response to the display of the plurality of images in the different areas on the display device of the HMD.

7. The method of claim 1, wherein a different plurality of images is displayed in different areas on the display device of the HMD each time the user is authorized for the HMD.

8. The method of claim 1, wherein the database indicating the habitual eye tracking data for the user is stored in a cloud-based data repository to be ingested by a machine learning computing system.

9. The method of claim 1, and further comprising:
collecting habitual eye tracking data for a plurality of users;
determining a habitual profile for each subset of the plurality of users; and
identifying a habitual profile for the user based on the maintained habitual eye tracking data for the user;
wherein the user is authorized based the sensed eye tracking data and the identified habitual profile for the user.

10. A computing system, comprising:
a display device;
a gaze tracking device; and
a processor operatively coupled with a computer readable storage medium and instructions stored on the computer readable storage medium that, when read and executed by the processor, direct the processor to:
display, by the display device, a pattern of images to a user;
capture, by the gaze tracking device, involuntary eye movements of the user viewing the pattern of images on the display device; and
authenticate the user based on the involuntary eye movements of the user matching a stored user preference information.

11. The computing system of claim 10, wherein the pattern of images includes images relating to different sceneries, colors, topics, or sizes that are of interest to the user.

12. The computing system of claim 10, wherein the involuntary eye movements include a duration of a pause of the user, a blink count of the user, or a pupillary variation of the user in response to the display of the pattern of images displayed on the display device.

13. The computing system of claim 10, wherein the user is authenticated by querying a machine learning computing system to authorize the user of the computing system based on the received involuntary eye tracking data and the stored user preference data.

14. The computing system of claim 10, wherein the stored user preference data is maintained in a cloud-based data repository.

15. A non-transitory computer-readable storage medium storing instructions that, when executed by a processor, cause the processor to:
maintain user preference data in a cloud-based data repository to be ingested by a machine learning computing system;
receive involuntary eye tracking data in response to displaying a sequence of images to a user of a head mountable device (HMD);
query the machine learning computing system to authorize the user of the HMD based on the received involuntary eye tracking data and the user preference data maintained in the cloud-based data repository.
